(19) United States
(12) Patent Application Publication
(10) Pub. No.: US 2004/0246428 A1
(43) Pub. Date: Dec. 9, 2004

(54) Liquid crystal display and portable display using the same

(76) Inventor: Yasuyuki Shirato, Fukushima-shi (JP)

Correspondence Address: Intellectual Property Law Group, Twelfth Floor, 12 South First Street, San Jose, CA, 95113, US

(21) Appl. No.: 10/492,927

(22) PCT Filed: Sep. 17, 2002
(86) PCT No.: PCT/JP02/09543

(30) Foreign Application Priority Data
Oct. 26, 2001 (JP) 2001-328883

(51) Int. Cl. G02F 1/1345

(52) U.S. Cl. 349/152

(57) ABSTRACT

It is an object of the invention to suppress product development costs and reduce in size by reducing the LSI-mounting area as small as possible of a liquid crystal display device attached with two or more LCDs. Transparent pixel electrodes of LCDs 3 and 13 are connected to each other in series via a FPC 9, and the transparent pixel electrodes of the LCDs 3 and 13 are electrically connected to a single LSI 7 of a circuit board portion 8 provided on a soft conductive connecting member. Therefore, the circuit board portion 8 and the FPC 9 can be reduced in size by being bent, thus the LCDs 3 and 13 can be used as display portions of a portable telephone or the like.

### TECHNICAL FIELD

The present invention relates to a liquid crystal display device and a portable display apparatus such as a portable telephone using this liquid crystal display.

### BACKGROUND ART

Conventionally, as a liquid crystal display device, a liquid crystal display element (hereinafter, this is sometimes referred to as a liquid crystal display portion or an LCD) where liquid crystals for display are filled between transparent substrates is known. A liquid crystal display device (hereinafter, this is sometimes referred to as an LCM or an LC module) where an LCD is driven by an LSI (IC) is shown in FIG. 13 (FIG. 13(a) is a plan view, and FIG. 13(b) is a partial sectional view along line A-A of FIG. 13(a)). The LC module comprises: a liquid crystal display portion (LCD) 23; wherein a front substrate 21 and a rear substrate 22, which are provided with conductive line as transparent electrodes, respectively, are aligned with each other and liquid crystals are filled in a pixel area sectioned with sealing members between both substrates 21 and 22 and a circuit board portion 29; wherein metallic copper conductive line 25 connected to conductive line from this liquid crystal display portion 23 is formed on a circuit board 27 made of a synthetic resin film such as a polyimide resin, and to an area where the metallic copper conductive line 25 is collected, an LSI (IC) 26 for connecting electrically to transparent pixel electrodes of the liquid crystal display portion 23 is connected via an ACF (anisotropic conductive film) 28. Both substrates 21 and 22 comprise transparent glass or transparent resin plates.

Conductive line of the LSI (IC) 26 on the circuit board portion 29 is structured to be connected to the power supply side via an anisotropic conductive film (unillustrated) and the like, however, in a construction shown in FIG. 13, the LSI 26 is placed on a synthetic resin film, therefore, such an LC module is sometimes referred to as a chip-on-film module.

Conventionally, as shown in FIG. 13, an LC module has employed a structure where one LCD 23 is driven by one LSI 26 (or a plurality of LSIs). When two LCDs 23 are attached to one product and driven in, for example, an LC module for a portable telephone as shown in FIG. 14, for respective LCDs 30 and 31 as a main LCD 30 and a rear LCD 31, LSIs 32 and 33 are respectively mounted on both surfaces of an opaque substrate 34, and on the rear surface sides of the display surfaces of the LCD 30 and LCD 31, backlight units composed of light-conductive plates 35 and 36 and LEDs 37 and 38 are attached, respectively.

In the case where two LCDs 30 and 31 are used in an LC module for a portable telephone as shown in FIG. 14, mounting of LSIs 32 and 33 in a respective manner for each of LCDs 30 and 31 results in formation of two LC modules, therefore, mask costs, inspection costs, and material costs become double, resulting in high product development costs and a high product cost. Furthermore, the LSIs 32 and 33, which are mounted to drive two or more LC modules, are not always LSIs of an identical type, therefore, it is necessary to prepare two types or more of software for driving the LCDs 30 and 31, resulting in high software development costs.

In addition, it is necessary to drive the two or more LC modules by one CPU, therefore, a great burden is imposed on the CPU.

In addition, in the case where two or more LCDs 30 and 31 are attached to one product, LSIs 32 and 33 are mounted, respectively, for each of the LCDs 30 and 31, therefore, the LSI-mounting area is increased, thus hindering downsizing of the product.

### DISCLOSURE OF THE INVENTION

It is an object of the present invention to suppress product development costs and reduce in size by reducing the LSI-mounting area as small as possible of a liquid crystal display device attached with two or more LCDs.

In addition, it is an object of the present invention to provide a display apparatus such as a portable telephone provided with a downsized liquid crystal display device with suppressed product development costs.

The above objects of the present invention will be achieved by the following inventions (1) through (4).

(1) A liquid crystal display device in which

two or more liquid crystal display portions (LCDs) are provided, wherein a first substrate provided with pixel electrodes and a second substrate provided with opposed pixel electrodes are aligned with each other so that both electrodes are oppositely arranged and liquid crystals are filled between the first substrate and second substrate,

in the pixel electrodes of the respective liquid crystal display portions (LCDs) composed of common electrodes and segment electrodes, the segment electrodes are connected in series to each other, and

a single circuit board portion (LSI) having an integrated circuit chip for connecting electrically to the pixel electrodes of all liquid crystal display portions (LCDs) is provided.

The pixel electrodes of the respective liquid crystal display portions (LCDs) in the liquid crystal display device of the present invention are, for example., composed of segment electrodes and common electrodes to be arranged to an active area of a liquid crystal display area and a viewing area provided on the outer periphery of this active area,

the segment electrodes having a series arrangement in the liquid crystal display area of the respective liquid crystal display portions (LCDS) are connected to the circuit board portion (LSI) via electrode conductive line shared among all liquid crystal display portions (LCDs), and

the common electrodes in the liquid crystal display area of the respective liquid crystal display portions (LCDs) are connected to the circuit board portion (LSI) via electrode conductive line provided on the viewing area of the liquid crystal display portion (LCD), whereby an advantage is provided such that even if a plurality of liquid crystal display portions (LCDs) are connected in series, the mounting area of a drive portion for the respective liquid crystal display portions (LCDs) is not increased.

In addition, it is desirable that connection between the pixel electrodes in the liquid crystal display areas of the respective liquid crystal display portions (LCDs) and connection between the pixel electrodes of one liquid crystal display portion (LCD) and circuit board portion (LSI) are carried out via electrode conductive line provided on a soft connecting means.

In addition, it is also satisfactory that connection between the pixel electrodes in the liquid crystal display areas of the respective liquid crystal display portions (LCDs) is carried out via electrode conductive line provided on a soft connecting means, and

the pixel electrodes of one liquid crystal display portion (LCD) out of these and the circuit board portion (LSI) are formed on the first substrate or the second substrate of this sole liquid crystal display portion (LCD).

The soft connecting means is selectively used from a flexible print circuit (FPC), a heat seal, a flexible flat cable (FFC), an anisotropic conductive rubber connector and the like.

In addition, as the respective liquid crystal portions (LCDS) having the first substrate and second substrate, liquid crystal display portions (LCDs) which are different from each other in area can be used where appropriate.

(2) A method for manufacturing a liquid crystal display device in which

first substrates and second substrates provided with, respectively, pixel electrodes and a liquid crystal injection area to be used in each of the respective liquid crystal display portions (LCDs) of the above liquid crystal display device (1) are all fabricated from one transparent glass plate or transparent synthetic resin plate having a large size for fabricating many sets of these two substrates.

In this case, by making the first substrate and second substrate identical in thickness, it becomes possible to obtain these two substrates by a multi-plate fabricating method from one transparent substrate having a large area, whereby productivity becomes higher than that of a case where the respective substrates are separately fabricated.

(3) A display apparatus provided with

the above liquid crystal display device of (1) wherein, out of a plurality of liquid crystal display portions (LCDS), one liquid crystal display portion (LCD) and another liquid crystal display portion (LCD) are arranged by bending the soft connecting means so that their respective liquid crystal display areas are faced in mutually opposite directions.

In addition, it is also satisfactory that the circuit board portion (LSI) of the display apparatus is arranged on the rear surface of anyone liquid crystal display portion (LCD) by bending the soft connecting means, and it is also satisfactory that the circuit board portion (LSI) is arranged on the first substrate or the second substrate of any one liquid crystal display portion (LCD).

In this case, a light-conductive plate and a light emitting source for a display by a backlighting method are arranged on the rear surface of the respective liquid crystal display portions (LCDS), the circuit board portion (LSI) is electrically connected to the pixel electrodes of a liquid crystal display portion (LCD) having the largest area, and the circuit board portion (LSI) is arranged on the rear surface of the liquid crystal display portion (LCD) having the largest area, whereby a portable display device downsized as a whole can be obtained.

Herein, a display apparatus of the present invention means a commercialized form of a liquid crystal display device of the present invention combined with other components including a backlight, a lamp, and a frame body.

(4) A folding portable telephone in which

the above liquid crystal display device of (1) wherein, out of a plurality of liquid crystal display portions (LCDS), one liquid crystal display portion (LCD) and another liquid crystal display portion (LCD) are arranged by bending the soft connecting means so that their respective liquid crystal display areas are faced in mutually opposite directions, and the circuit board portion (LSI) is arranged on any one rear surface of liquid crystal display portions (LCDS) by bending the soft connecting means, is provided in a collapsible cover body of a telephone main body.

According to the liquid crystal display device of the present invention, it is also possible to, by connecting respective segment electrodes of two or more LCDS in series, drive the two or more LCDs by a single LSI simultaneously or separately.

Even though a plurality of LCDs of an LCD module of the present invention are identical in the number of respective segment electrodes, common electrodes of an LCD arranged distant from an LSI are passed through the inside of a viewing area of an LCD arranged close to the LSI (passed through the inside of an end portion of a glass substrate of the LCD), therefore, the plurality of liquid crystal display element LCDs can be made identical in terms of one of the outside dimensions. In a multi-plate fabricating method from one large plate for LCDS, fabrication by photolithography using only one pixel electrode-forming mask can be carried out, therefore, LCDs can be economically manufactured.

In addition, a low cost, space-saving liquid crystal display device can be provided, wherein two or more separately fabricated LCDs are connected to each other via a flexible conductive cable, an anisotropic rubber connector or the like, an LSI is mounted on one of the LCDs, and the other LSI(s) is/are driven via respective segment electrodes by this single LSI simultaneously or separately.

In addition, by connecting two or more LCDs to each other and one of the LCDs and a single LSI, respectively, via a soft connecting means such as a flexible conductive cable or an anisotropic conductive rubber connector and folding up the soft connecting means, the LCD and LSI can be overlapped, whereby a space-saving liquid crystal display device can be obtained.

In addition, by arranging the LSI-mounted surface at a position opposed to the LCD in a folded-up manner, an integrated circuit chip is not exposed from the substrate surface of the LCD, therefore, when a display apparatus is fabricated by setting a liquid crystal display device in a frame body, external shock to the integrated circuit chip can be prevented. A variety of combinations exist for an LCD as a set of a first substrate and a second substrate where transparent pixel electrodes and a liquid crystal injection area of the liquid crystal display device of the present invention are formed, however, by making the first substrate and second substrate identical in plate thickness, it becomes possible to obtain, from one transparent substrate having a large area, a plurality of LCD substrates with pixel electrodes electrically connected as a set of two substrates in a multi-plate fabricating method from one large plate, therefore, productivity becomes higher than the case where the respective substrates are separately fabricated. Namely, according to the method for manufacturing a liquid crystal display device of the present invention, by using the plurality sets of substrates fabricated from one large plate as one transparent substrate, pixel electrodes can be collectively fabricated in a lump through one photolithography process.

In the prior manufacturing method, one or two masks which are required, respectively, for the first substrate and second substrate for a liquid crystal display portion have been necessary, however, in the present invention, since the various transparent electrodes can be formed at a single time by means of one transparent substrate having a large area, therefore, one mask is sufficient, and consequently, the exposure process and patterning process are reduced to half or less.

### BRIEF DESCRIPTION OF THE DRAWINGS

FIG. 1(a) is a developed perspective view of a liquid crystal display device according to an embodiment of the invention, and

FIG. 1(b) is a partial sectional view of the same,

FIG. 2 is a plan view of LCDs according to an embodiment of the invention,

FIG. 3(a) is a plan view of a multiple substrate to be used in fabrication of the LCDs of FIG. 2, and FIG. 3(b) is a side view in a condition where a multiple substrate is double bonded,

FIG. 4 is a flowchart showing procedures for fabricating the LCDs of FIG. 2,

FIG. 5 are perspective views showing a circuit board portion and conductive line provided on an FPC according to an embodiment of the invention,

FIG. 6 is a developed plan view of a liquid crystal display device according to an embodiment of the invention,

FIG. 7 is an LCD conductive line diagram of a liquid crystal display device according to an embodiment of the invention,

FIG. 8 is a side view in a condition where a liquid crystal display device according to an embodiment of the invention is bent,

FIG. 9 is a schematic sectional view of a portable telephone in a condition where the bent liquid crystal display of FIG. 8 is incorporated in a portable telephone,

FIG. 10 is a schematic sectional view of the portable telephone of FIG. 9 whose cover is closed,

FIG. 11 is a developed perspective view of a liquid crystal display device according to an embodiment of the invention,

FIG. 12 is a side view in a condition where the liquid crystal display of FIG. 11 is bent,

FIG. 13 are views showing a prior-art LC module, wherein FIG. 13(a) is a perspective view and FIG. 13(b) is a partial sectional view along line A-A of FIG. 13(a), and

FIG. 14 is a side view in a condition where a prior-art liquid crystal display is bent.

### BEST MODE FOR CARRYING OUT THE INVENTION

An embodiment of the present invention will be described in detail with reference to the drawings.

First, procedures for manufacturing a liquid crystal display device (LC module) of the present embodiment wherein two LCDs are driven by a single LSI (IC) will be described.

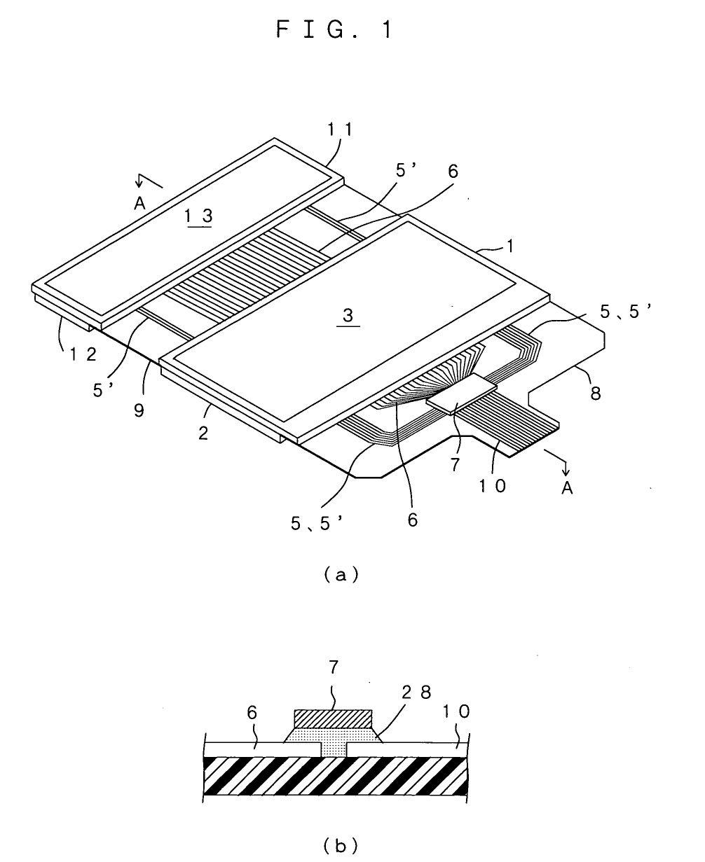

Developed views of a liquid crystal display device (LC module) wherein two LCDs are driven by a single LSI (IC) obtained according to the manufacturing procedures of the present embodiment are shown in FIG. 1 (FIG. 1(a) is a perspective view, and FIG. 1(b) is a partial sectional view along line A-A of FIG. 1(a)).

An LC module is constructed such that:

an LCD 3 and an LCD 13 wherein a set of a front substrate 1 and a rear substrate 2 and a set of a front substrate 11 and a rear substrate 12, which are provided with conductive line as transparent electrodes, respectively, are aligned with each other and liquid crystals are filled in pixel areas sectioned by sealing members between both substrates 1 and 2 and both substrates 11 and 12, and metallic copper common electrode conductive line 5 and 5′ and segment electrode conductive line 6 connected to electrode conductive line of the LCD 3 and the LCD 13 are formed on the surfaces of a circuit board portion 8 and FPC (flexible print circuit) 9 made of a synthetic resin film such as a polyimide resin, and to an area where the metallic copper conductive line 5, 5′ and 6 is collected, an LSI (IC) 7 for connecting electrically of the transparent pixel electrodes of the LCD 3 and LCD 13 is connected via an ACF 28. Both substrates 1 and 2 and both substrates 11 and 12 are formed of transparent glass or transparent resin plates. Lead conductive line 10 is structured to be connected to the power supply side via an anisotropic conductive film (unillustrated) or the like of the LSI (IC) 7 on the circuit board portion 8, however, in a construction shown in FIG. 1, since the LSI 7 is placed on a synthetic resin film, such an LC module is sometimes referred to as a chip-on-film (COF) module.

Hereinafter, an embodiment of a method for manufacturing a liquid crystal display element according to the LC module of FIG. 1 will be described.

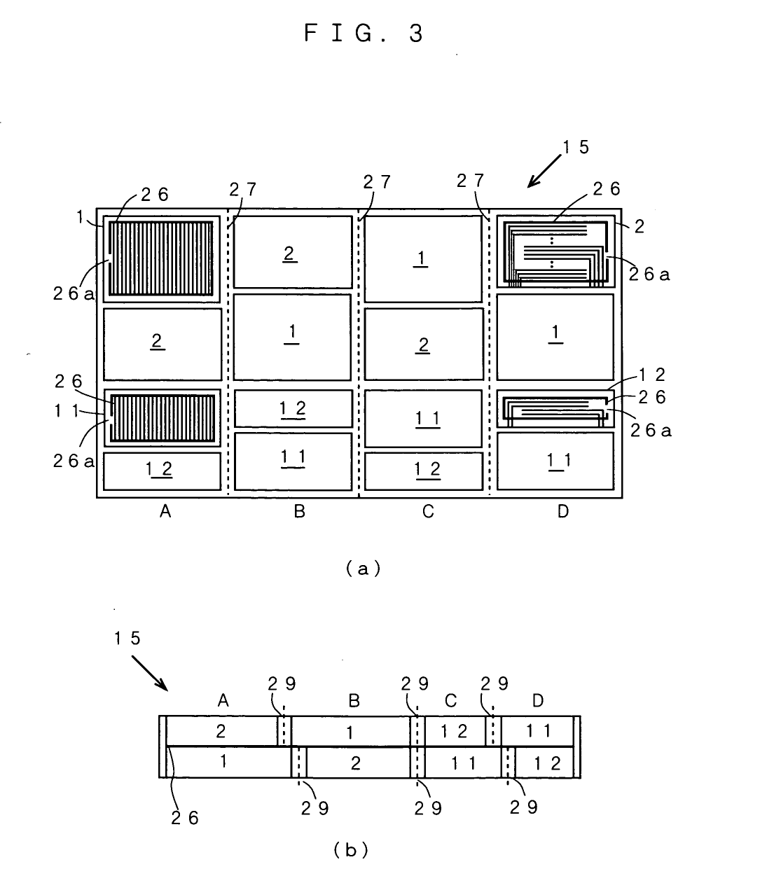

A glass substrates 15 for fabricating a plurality substrates form one large glass substrate (hereinafter, referred as “a multiple glass substrate”) with a transparent conductive film is prepared, wherein an ITO transparent conductive film is coated by a sputtering method or the like with a film thickness having an appointed electrical resistance on one surface of a transparent glass plate (with an alkaline elution preventive film of SiO₂). By means of this transparent conductive film, patterning of pixel electrodes is carried out so that arrangement of the two opposed glass substrate 1 and glass substrate 2 of the liquid crystal display portion 3 and the two opposed glass substrate 11 and glass substrate 12 of the liquid crystal display portion 13 becomes as shown in FIG. 3(a).

FIG. 3(a) shows a case where two types of paired two liquid crystal display portions (LCDs) (two LCDs 3 from the substrates 1 and 2 and two LCDs 13 from the substrates 11 and 12) are manufactured from one multiple glass substrate 15. Namely, this shows a multiple arrangement wherein four LC modules each constructed by coupling segment electrodes of the LCD 3 and segment electrode of the LCD 13 as shown in FIG. 1 coupled in series can be manufactured. In terms of the first file (file A) and third file (file C) from the left end of the glass substrate 15, respectively, pixel electrodes of glass substrates 1, 2, 11, and 12 have been patterned in the top-to-bottom direction on the glass substrates by photolithography. To the glass substrates 1 and 11, electrode patterning resulting in segment electrodes is applied, and to the glass substrates 2 and 12, electrode patterning resulting in a common electrode is applied. In FIG. 3(a), the patterned pixel electrodes resulting in segment electrodes or common electrodes have been illustrated on only one of the respective glass plates 1, 2, 11, and 12.

On the second file (file B) and fourth file (file D) from the left side, glass substrates 2, 1, 12, and 11 are arranged in the top-to-bottom direction in this order. A process liquid for crystal orientation such as a polyimide precursor containing liquid is applied to the glass substrate 2, 1, 12, and 11 and heat-set, whereby a polyimide orientation-processed film is provided. Thereafter, liquid crystal seals 26 (which are formed by applying an epoxy resin to become an appointed shape and an appointed thickness by screen printing and heat-setting this epoxy resin) to be sealed between the two glass substrates 1 and 2 and the two glass substrates 11 and 12 is formed on the oriented film. The liquid crystal seal 26 has a notched portion to serve as a liquid crystal inlet 26a in a later process per each of the LCDs 3 and 13.

As shown in a sectional view of FIG. 3(b), two glass substrates 15 after electrode patterning, a crystal orientation process, and a crystal seal 26 formation as such are bonded to each other with their electrode surfaces faced inside, whereby a multiple glass substrate is obtained, wherein the two glass substrates are bonded to each other by thermo-compression bonding at a liquid crystal seal portion. Thereafter, at positions of primary cut lines 27 indicated by the dotted lines shown in FIG. 3(a), cutter lines are scribed by a diamond cutter on both outside surfaces of the glass and the glass is cut and separated, whereby four bonded glass bodies are obtained. A section of such a bonded glass body is shown in FIG. 3(b).

One of the bonded glass bodies thus obtained is composed of an aggregate of liquid crystal cells resulting in four liquid crystal display portions. These liquid crystal cells have liquid crystal inlets 26a formed on an identical side, respectively, therefore, liquid crystals can be injected by a normal method for a collective injection in a reduced-pressure atmosphere. After liquid crystals (nematic liquid crystals) are injected in the cells, a UV curing resin is applied to the liquid crystal inlets 26a and cured by UV irradiation, thereby sealing the liquid crystals in the liquid crystal cells. The bonded glass body is cut into four pieces by scribing cutter lines with a diamond cutter from file A of FIG. 3(a) along secondary cut lines 29 shown by the dotted lines indicated by dotted lines of FIG. 3(b), whereby two liquid crystal display portions (LCDs 3) and two liquid crystal display portions (LCDs 3), that are, liquid crystal display portions corresponding to two LC modules shown in FIG. 1 can be simultaneously fabricated.

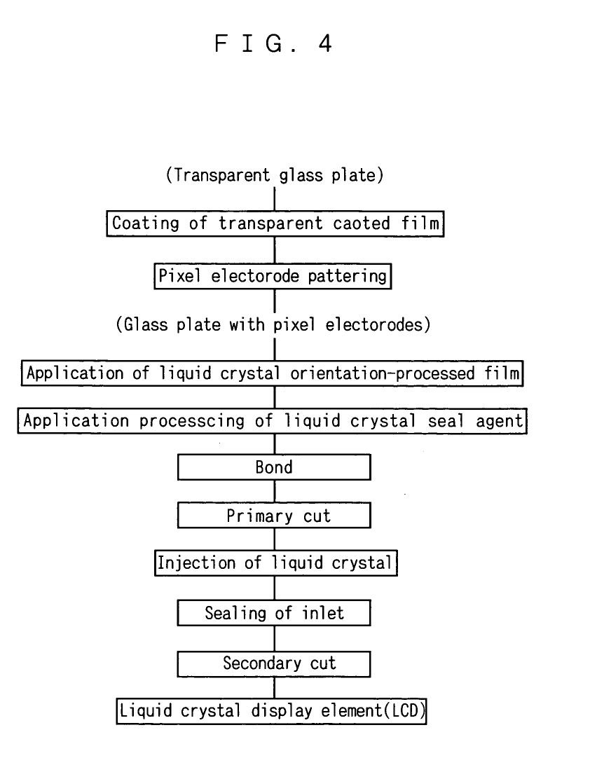

The foregoing LCD forming procedures are shown in FIG. 4.

Effects described with reference to FIG. 3 and FIG. 4 are as follows. Namely, a set of two liquid crystal display portions can be fabricated from one multiple glass substrate 15, therefore, one masking pattern is sufficient for photolithography in the pixel electrode process. In addition, since the multiple glass substrate 15 can be made in one size, one type of substrate transferring jig is sufficient.

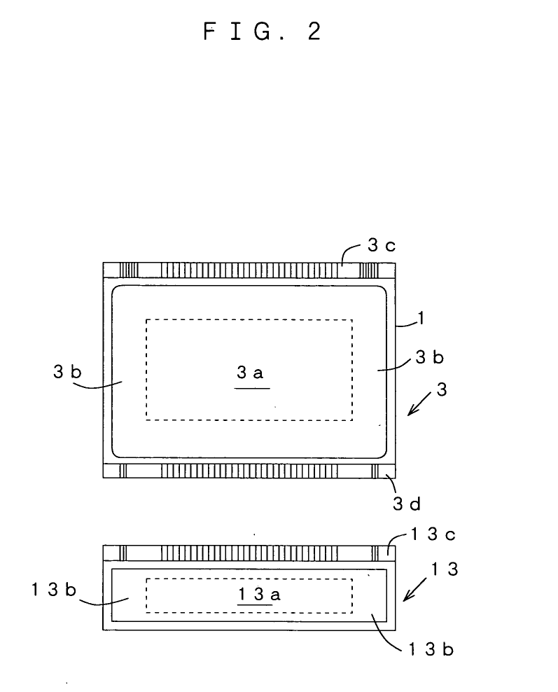

In order to connect electrode conductive line terminals 3c and 3d (FIG. 2) of the LCD 3 to electrode conductive line terminals of the circuit board portion 8 mounted with the LSI 7 and the FPC 9, respectively, and in order to connect an electrode conductive line terminal 13c of the LCD 13 to a conductive line electrode terminal of the FPC 9, electrode conductive line is formed up to the end portions of the respective LCDs 3 and 13, as shown in FIG. 2. In addition, an active area 3a and a viewing area 3b of the LCDs 3 and 13 are shown in FIG. 2.

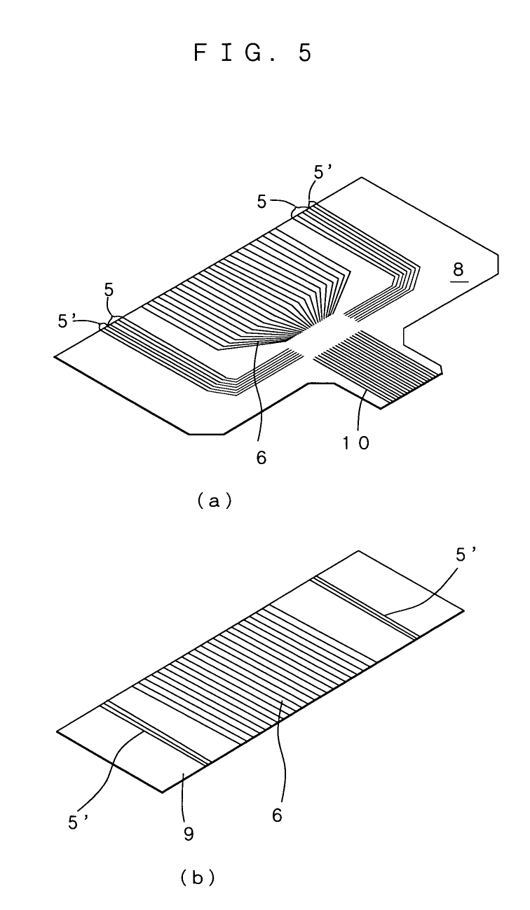

Then, as shown in FIG. 5, copper conductive line of the electrode conductive line 5, 5′ and 6 is formed by photolithography on the circuit board portion 8, and conductive line of the electrode conductive line 5′ is formed by photolithography on the FPC 9, as well. The electrode connection terminal 3d of the LCD 3 and conductive line of the electrode conductive line 5, 5′ and 6 of the circuit board portion 8 as shown in FIG. 5 are connected, respectively, and electrode conductive line 5′ and 6′ of the FPC 9 is connected between the electrode connection terminal 3c of the LCD 3 and electrode connection terminal 13c of the LCD 13, thus an LCM as shown in FIG. 1 is fabricated.

Herein, instead of providing the LSI 7 on the FPC 9 as shown in FIG. 1, the LSI 7 may be provided on the electrode conductive line terminal 3c by increasing the area of a part of the glass substrate 1 where the electrode conductive line terminal 3c is provided.

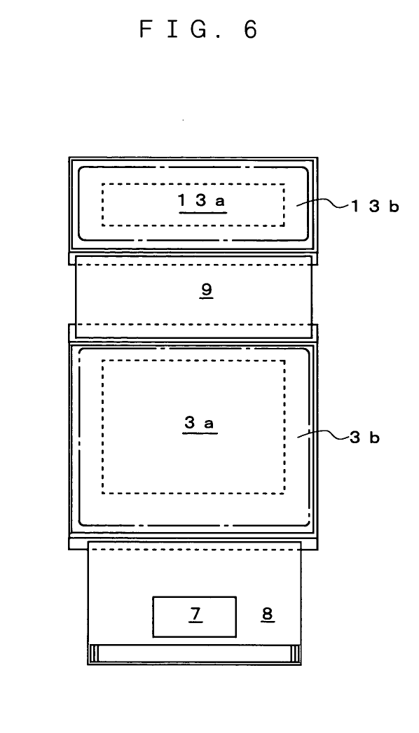

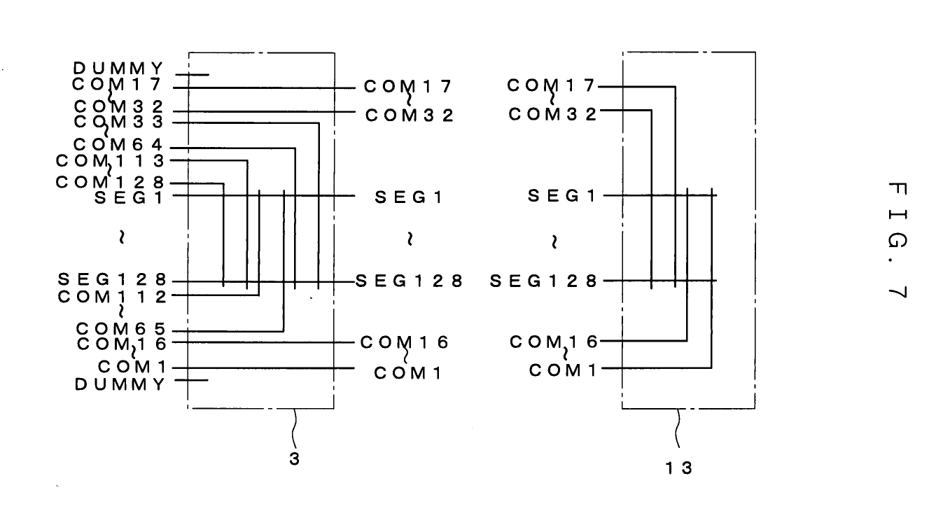

In FIG. 6, an arrangement relationship diagram among the active area 3a and viewing area 3b of the LCDS 3 and 13, LSI 7, and others as shown in FIG. 1 is shown, and in FIG. 7, a conductive line diagram of the electrode conductive line 5, 5′ and 6 of the LCDs 3 and 13 as shown in FIG. 1 is shown.

The LCD 3 and LCD 13 are provided with 128 shared segment electrodes (SEGs 1-128). In addition, the LCD 3 is provided with 96 common electrodes (COMs 33-64, COMs 65-112, and COMs 113-128), and the LCD 13 is provided with 32 common electrodes (COMs 1-16 and COMs 17-32). These segment electrodes are controlled in terms of conduction by one LSI 7 connected to the electrode conductive line 6 of the circuit board portion 8. In addition, the 96 common electrodes of the LCD 3 are connected to the electrode conductive line 5 of the circuit board portion 8, and the 32 common electrodes of the LCD 13 are connected to the electrode conductive line 5′ of the circuit board 8 via the electrode conductive line 5′ of the FPC 9, and these are controlled in terms of conduction by the LSI 7, respectively.

In addition, the electrode conductive line 5 of the LCD 3 is provided so as to pass through the inside of the viewing area 3b of the LCD 3, and is bent at a right angle inside the viewing area 3b and connected electrically on the glass substrate 2. In addition, the electrode conductive line 5, of the circuit board portion 8 is provided so as to pass through the viewing area 3b of the LCD 3 and the viewing area 13b of the LCD 13.

As such, in terms of the LCD 3 and LCD 13 whose segment electrodes are identical, the common electrodes of the LCD 3 are connected electrically (ITO transparent electrodes, by patterning) on the glass substrate 2 so as to bend at a right angle inside the viewing area 3b of the LCD 3, and the common electrodes of the LCD 13 are guided to the inside of the viewing area 13b of the LCD 13 through the inside of the viewing area 3b of the LCD 3 and connected electrically on the glass substrate 12 so as to bend at a right angle inside the viewing area 13b of the LCD 13, therefore, the outside dimension of the glass substrates 1, 2, 11, and 12 in the width direction of the LCD 3 and LCD 13 can be made identical.

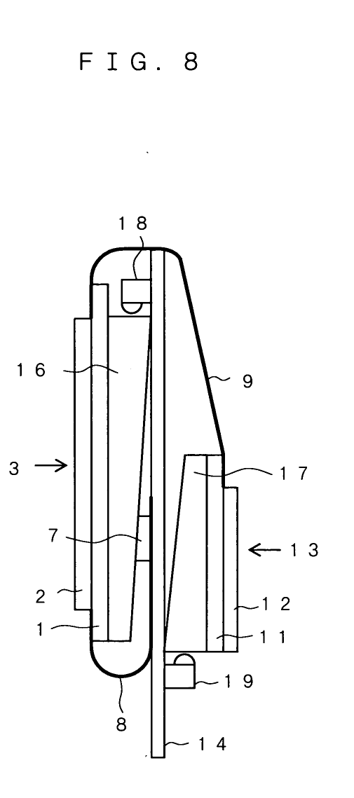

In addition, in the present embodiment, the circuit board portion 8 which connects between the LSI 7 and LCD 3 and the FPC 9 which connects between the LCD 3 and LCD 13 are made of flexible conductive cables, respectively, and therefore can be bent. Accordingly, as shown in FIG. 8, the LCD 13 can be arranged on the rear side of the LCD 3.

As methods for mounting the LSI 7 on the LCD 3, various connection modes including a combination of a COG (Chip on Glass), COF (Chip on Film), TAB (Tape Automated Bonding), COS (Chip on Stick), or QFP (Quad Flat Package) substrate and a flexible cable, a combination of a COB (Chip on Board) substrate and a flexible cable and the like can be used.

In the present embodiment, the flexible FPC 9 is used for connection between the LCD 3 and LCD 13, however, a rigid connection terminal such as a lead frame or an anisotropic conductive rubber connector may also be used.

In addition, as shown in FIG. 8, the LCD 3 and LCD 13 are mounted on both surfaces of a printed circuit board 14 so that display surfaces thereof are faced in mutually opposite directions, the FPC 9 is arranged in a bent fashion so that these LCDs 3 and 13 are back to back with each other, the circuit board portion 8 as LSI 7-laded portion is also arranged on the rear surface of the LCD 3, and on the rear surface sides of the display surfaces of the LCD 3 and LCD 13, backlight units composed of light-conductive plates 16 and 17 and LCDs 18 and 19 are attached, respectively, whereby the LCD 3 and LCD 13 can be easily fixed.

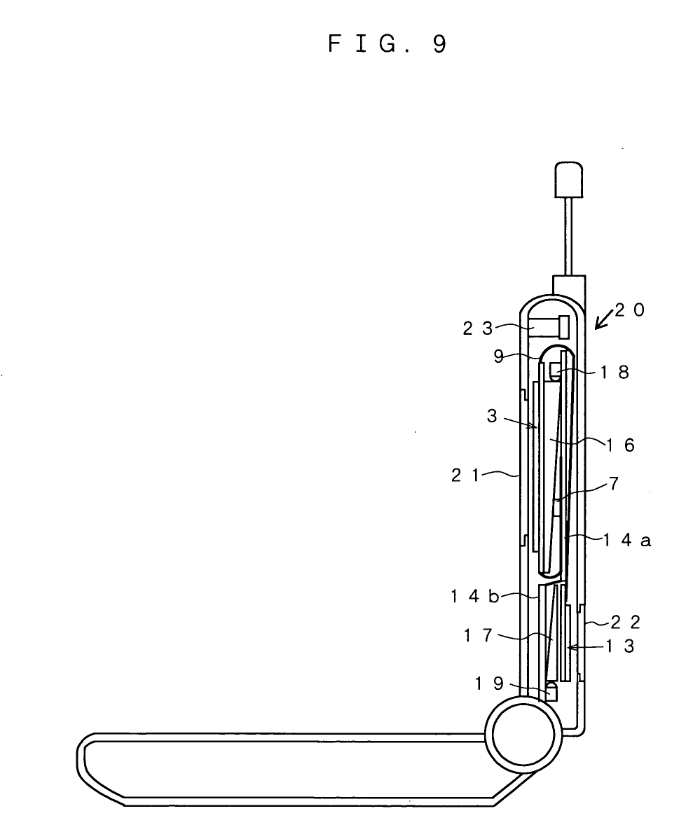

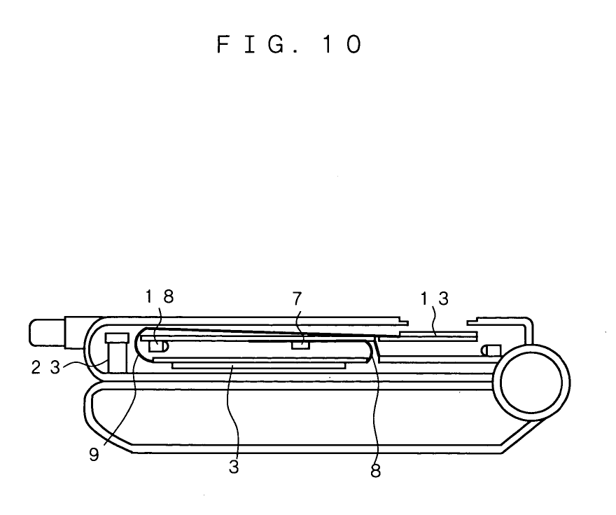

By using a liquid crystal display unit attached with backlight units as shown in FIG. 8 as a display portion of a portable telephone as shown, for example, in FIG. 7, an image display becomes possible on both front and rear surfaces. As shown in the schematic sectional view of a portable telephone of FIG. 7 (FIG. 9 shows a condition where the cover is opened, and FIG. 10 shows a condition where the cover is closed.), the liquid crystal display unit of FIG. 8 is incorporated in a cover 20 portion of a folding-up type portable telephone, and in general, the LCD 3 having a relatively large display area is arranged so that a display becomes possible on the rear side of the cover 19, and the LCD 13 having a relatively small display area is arranged so that a display becomes possible on the front side of the portable telephone cover. Thus, important display information can be read from the LCD 3 by opening the cover, and simple information such as a notice of an incoming call and the date can be read from the LCD 13 on the front side of the portable telephone cover. The portable telephone as shown in FIG. 7 is an example where a transparent cover 21 is provided on the display surface side of the LCD 3, and a transparent cover 22 is provided on the display surface side of the LCD 13, moreover, the printed circuit board 14 is composed of two portions 14a and 14b, and a speaker 23 is also built-in.

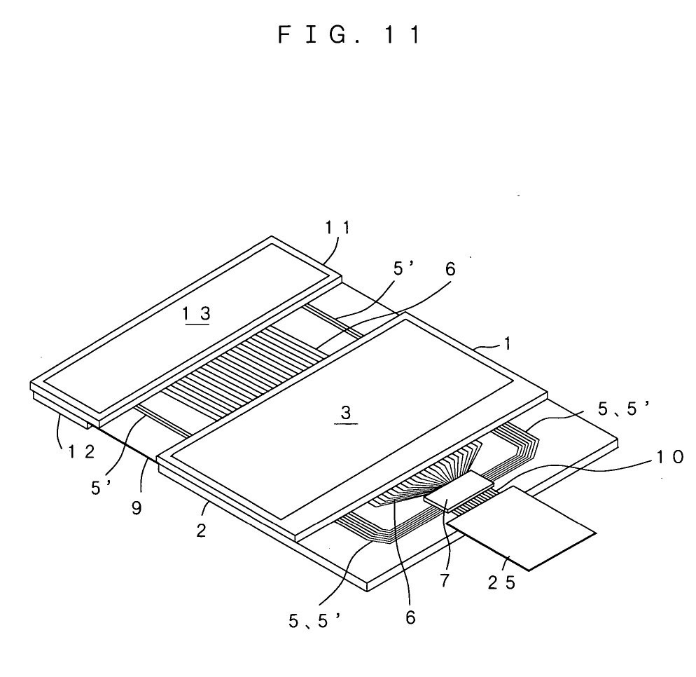

A developed perspective view of a liquid crystal display device according to a COG-type embodiment where an LSI 7 is mounted on an LCD 3 is shown in FIG. 11. As for numbers used for members shown in FIG. 11, identical numbers are used for members identical to those of the liquid crystal display device of FIG. 1 and description thereof will be omitted.

In order to mount the LSI 7 on a glass substrate 2 of the LCD 3, electrode conductive line 5, 5′, 6, and 10 is formed on the glass substrate 2, and the LSI 7 is connected electrically to this electrode conductive line. The electrode conductive line 10 is connected to a power supply via conductive line electrodes (unillustrated) on a soft connecting member 25 made of a synthetic resin such as a polyimide resin.

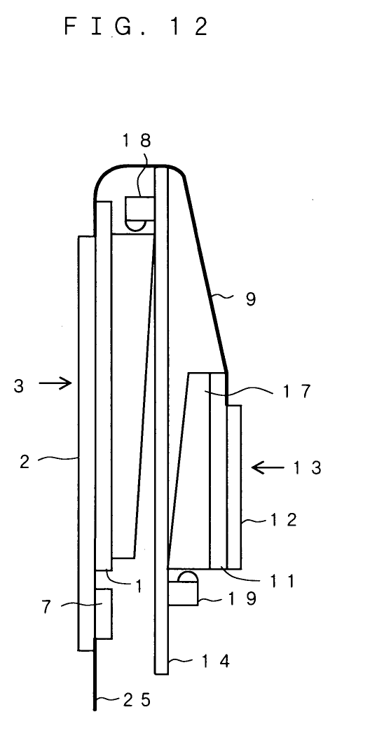

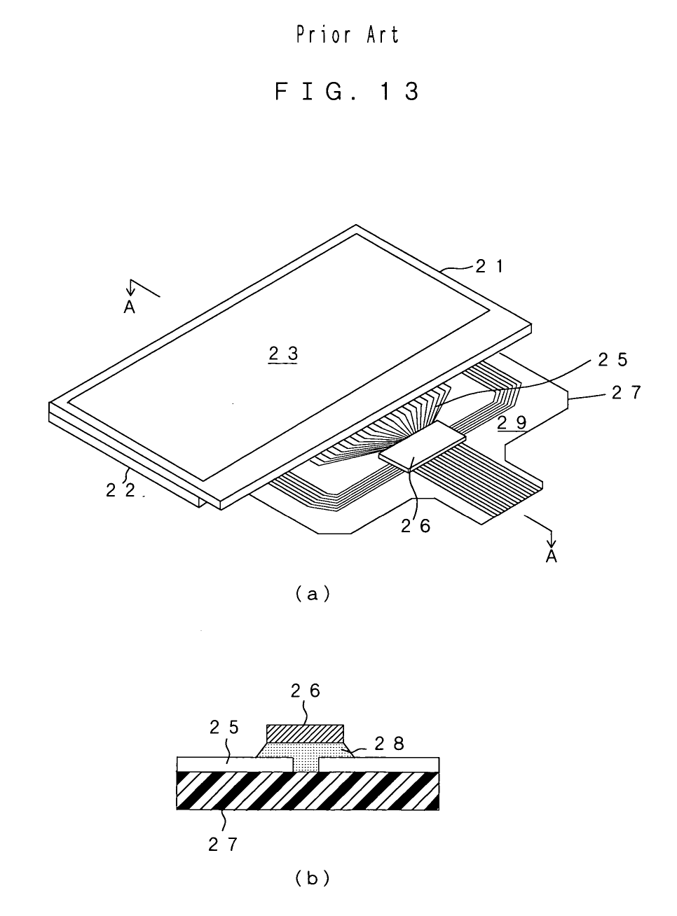

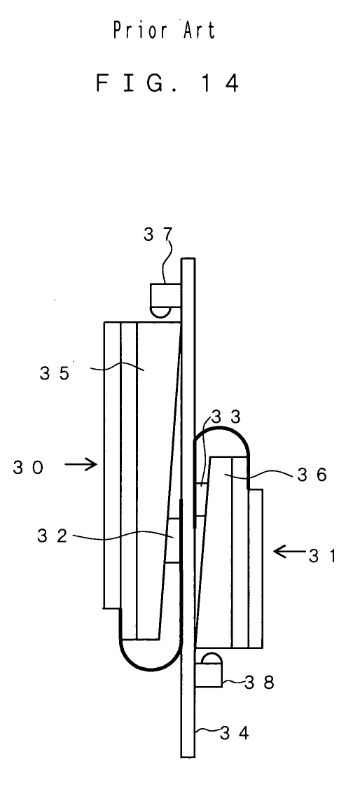

In this case as well, as shown in FIG. 12, by bending the FPC 9, the LCD 3 and LCD 13 are arranged on the front and rear surfaces of the printed circuit board 14, whereby a small-sized liquid crystal display device can be obtained.

### INDUSTRIAL APPLICABILITY

According to the present invention, two or more LCDs can be driven by one LSI, therefore, the quantity of LSIs can be reduced. In addition, since the LSI input terminal is provided at one spot, the area of a connecting portion to the LSI setting side and man-hours for connection can be reduced, therefore, the mounting area and mounting man-hours of an LC module can be decreased, thus commercialization can be realized at low cost.

In addition, conductive line which is shared between two or more LCDs can be provided, therefore, the development costs for LCD driving software can be reduced and the development period therefor can be shortened. In addition, since one LSI is provided, the time that is spent by a CPU in driving LCDs can be reduced, therefore, a burden to the CPU becomes small.

Consequently, it becomes possible to obtain a folding portable telephone provided with a downsized liquid crystal display device with suppressed product development costs.

1-12. (canceled)

13. A liquid crystal display device in which
two or more liquid crystal display portions (LCDs) are provided, wherein a first substrate provided with pixel electrodes as segment electrodes, and a second substrate provided with opposed pixel electrodes as common electrodes, are aligned with each other so that said both electrodes are oppositely arranged and liquid crystals are filled between said first substrate and second substrate,
the pixel electrodes of said respective liquid crystal display portions (LCDs) are arranged to an active area of a liquid crystal display area and a viewing area provided on the outer periphery of this active area,
the segment electrodes of said respective liquid crystal display portions (LCDs) are connected in series to each other,
a single circuit board portion (LSI) having an integrated circuit chip for connecting electrically to the pixel electrodes of all liquid crystal display portions (LCDs) is provided,
the segment electrodes having a series arrangement in the liquid crystal display area of the respective liquid crystal display portions (LCDs) are connected to the circuit board portion (LSI) via electrode conductive line shared among all liquid crystal display portions (LCDs), and
the common electrodes in the liquid crystal display area of the respective liquid crystal display portions (LCDs) are connected to said circuit board portion (LSI) via said pixel electrodes provided on the viewing area of the liquid crystal display portion (LCD).

14. A liquid crystal display device as set forth in claim 13, wherein connection between the pixel electrodes in the liquid crystal display areas of said respective liquid crystal display portions (LCDs) and connection between the pixel electrodes of one liquid crystal display portion (LCD) and circuit board portion (LSI) are carried out via electrode conductive line provided on a soft connecting means.

15. A liquid crystal display device as set forth in claim 14, wherein connection between the pixel electrodes in the liquid crystal display areas of said respective liquid crystal display portions (LCDs) is carried out via electrode conductive line provided on a soft connecting means, and
the pixel electrodes of one liquid crystal display portion (LCD) out of these and the circuit board portion (LSI) are formed on the first substrate or the second substrate of this sole liquid crystal display portion (LCD).

16. A liquid crystal display device as set forth in claim 14, wherein said soft connecting means is any of a flexible print circuit (FPC), a heat seal, a flexible flat cable (FFC), and an anisotropic conductive rubber connector.

17. A liquid crystal display device as set forth in claim 15, wherein said soft connecting means is any of a flexible print circuit (FPC), a heat seal, a flexible flat cable (FFC), and an anisotropic conductive rubber connector.

18. A liquid crystal display device as set forth in claim 13, wherein the respective liquid crystal portions (LCDs) having said first substrate and second substrate are different from each other in area.

19. A liquid crystal display device as set forth in claim 14, wherein the respective liquid crystal portions (LCDs) having said first substrate and second substrate are different from each other in area.

20. A liquid crystal display device as set forth in claim 15, wherein the respective liquid crystal portions (LCDs) having said first substrate and second substrate are different from each other in area.

21. A liquid crystal display device as set forth in claim 16, wherein the respective liquid crystal portions (LCDs) having said first substrate and second substrate are different from each other in area.

22. A method for manufacturing a liquid crystal display device in which first substrates and second substrates provided with, respectively, pixel electrodes and a liquid crystal injection area to be used in each of the respective liquid crystal display portions (LCDs) of a liquid crystal display device as set forth in any of claims 13 through 21 are all fabricated from one transparent glass plate or synthetic resin plate having a large size in a multi-plate fabricating method.

23. A display apparatus provided with a liquid crystal display device as set forth in any of claims 13 through 21, wherein out of a plurality of liquid crystal display portions (LCDs), one liquid crystal display portion (LCD) and another liquid crystal display portion (LCD) are arranged by bending the soft connecting means so that their respective liquid crystal display areas are faced in mutually opposite directions.

24. A display apparatus provided with a liquid crystal display device as set forth in claim 23, wherein the circuit board portion (LSI) is arranged on the rear surface of any one liquid crystal display portion (LCD) by bending the soft connecting means.

25. A display apparatus provided with a liquid crystal display device as set forth in claim 23, wherein the circuit board portion (LSI) is arranged on the first substrate or the second substrate of any one liquid crystal display portion (LCD).

26. A display apparatus as set forth in claim 23, wherein provided with
a light-conductive plate and a light emitting source for a display by a backlighting method are arranged on the rear surface of the respective liquid crystal display portions (LCDs), and the circuit board portion (LSI) is electrically connected to the pixel electrodes of a liquid crystal display portion (LCD) having the largest area.

27. A display apparatus as set forth in claim 24, wherein provided with a light-conductive plate and a light emitting source for a display by a backlighting method are arranged on the rear surface of the respective liquid crystal display portions (LCDs), and the circuit board portion (LSI) is electrically connected to the pixel electrodes of a liquid crystal display portion (LCD) having the largest area.

28. A display apparatus as set forth in claim 25, wherein provided with a light-conductive plate and a light emitting source for a display by a backlighting method are arranged on the rear surface of the respective liquid crystal display portions (LCDs), and the circuit board portion (LSI) is electrically connected to the pixel electrodes of a liquid crystal display portion (LCD) having the largest area.

29. A folding portable telephone in which a liquid crystal display device as set forth in any of claims 13 through 21 wherein, out of a plurality of liquid crystal display portions (LCDs), one liquid crystal display portion (LCD) and another liquid crystal display portion (LCD) are arranged by bending the soft connecting means so that their respective liquid crystal display areas are faced in mutually opposite directions is provided in a collapsible cover body of a telephone main body.
